(19) United States
(12) Patent Application Publication
(10) Pub. No.: US 2025/0013998 A1
(43) Pub. Date: Jan. 9, 2025

(54) METHODS AND SYSTEMS FOR TRANSACTION PROCESSING USING A BLOCKCHAIN

(71) Applicant: DBS Bank LTD., Singapore (SG)

(72) Inventors: Peng Khim NG, Singapore (SG); Li Khim ANG, Singapore (SG); Zhenqian TAY, Singapore (SG); Xiaomeng LIU, Singapore (SG)

(21) Appl. No.: 18/710,465

(22) PCT Filed: Nov. 16, 2022
(86) PCT No.: PCT/SG2022/050828

§ 371 Date: May 15, 2024

(30) Foreign Application Priority Data
Nov. 16, 2021 (SG) 10202112740U

(51) Int. Cl. G06Q 20/08

(52) U.S. Cl. CPC G06Q 20/0855

(57) ABSTRACT

A transaction processing method comprises: receiving a transaction initiation request for a payment transaction involving a plurality of transaction parties; generating a smart contract instance for the payment transaction and storing the smart contract instance in a smart contract on a blockchain, the smart contract having a plurality of conditions which must be fulfilled prior to execution of the payment transaction, wherein the plurality of conditions comprises transaction party conditions which must be fulfilled by respective transaction parties from the plurality of transaction parties; for each transaction party condition of the transaction party conditions: sending a message to a respective transaction party corresponding to the transaction party condition; receiving a response from the respective transaction party indicating that the respective transaction party condition has been fulfilled; and updating the smart contract to indicate that the respective transaction party condition has been fulfilled; in response to determining that each condition of the plurality of conditions has been fulfilled, sending a transaction execution message to a transaction execution party of the plurality of transaction parties to execute part of the payment transaction; receiving a transaction execution response from the transaction execution party indicating that a part of the transaction has been executed; and updating the smart contract to indicate that the part of the transaction has been executed.

### TECHNICAL FIELD

The present disclosure relates to the processing of payment transactions using a blockchain.

### BACKGROUND

Currently, transactions such as payments and fund transfers are performed via networks including the SWIFT network, Real Time Gross Settlement (RTGS), clearing house networks and other commercial payment networks. These networks are acting mainly as message forwarders. There is a lack of transparency on the transaction status while using these networks. Payments or fund transfers may be rejected by financial institutions in the payment flow for various reasons such as an invalid account number, an invalid account holder name, or a sanction screening hit.

A long processing time is often required to handle exceptions and uncertain transactions. Often a manual intervention involving time and effort is needed to coordinate with the intermediary and beneficiary banks to facilitate communications and returns.

### SUMMARY

According to a first aspect of the present disclosure a transaction processing method is provided. The transaction processing method comprises: receiving a transaction initiation request for a payment transaction involving a plurality of transaction parties;
generating a smart contract instance for the payment transaction and storing the smart contract instance in a smart contract on a blockchain, the smart contract having a plurality of conditions which must be fulfilled prior to execution of the payment transaction, wherein the plurality of conditions comprises transaction party conditions which must be fulfilled by respective transaction parties from the plurality of transaction parties; for each transaction party condition of the transaction party conditions: sending a message to a respective transaction party corresponding to the transaction party condition; receiving a response from the respective transaction party indicating that the respective transaction party condition has been fulfilled; and updating the smart contract to indicate that the respective transaction party condition has been fulfilled; in response to determining that each condition of the plurality of conditions has been fulfilled, sending a transaction execution message to a transaction execution party of the plurality of transaction parties to execute part of the payment transaction; receiving a transaction execution response from the transaction execution party indicating that a part of the transaction has been executed; and updating the smart contract to indicate that the part of the transaction has been executed.

The transacting processing method is deployed on blockchain infrastructure. Participants to the platform will set up and host the nodes of the platform. Indexer Services are configured to each node to facilitate interaction with the blockchain. The method provides a payment utility platform which integrates and interacts with channels which will receive and respond to the different requirements of the transaction throughout its lifecycle. Channels will also function to initiate payment/fund transfer to the platform.

The invention of the Payment Utility Platform via the use of Smart Contracts introduces programmable payments where the Payment Utility orchestrates the end to end fund transfer/payment lifecycle before effecting the transfer based on pre-defined conditions. The Payment Utility Platform is designed to operate 24/7 with high availability.

Methods and systems of the present disclosure provide the following benefits:

### 1. Transparency

All transactions and updates are recorded on the blockchain. This is transparent and visible to participants to the Payment Utility Platform. Participants may also host a node and own a copy of the data and smart contract codes deployed on the blockchain. In this, they will also receive all events and transactions that occur on the blockchain via their node. This provides transparency and visibility.

### 2. Finality

The Payment Utility Platform will record all the stages of a transaction lifecycle and updates on conditions fulfilment from participants on the blockchain. The Payment Utility Platform will confirm all pre-defined conditions are fulfilled before the effecting of payment/fund transfer and the movement of funds. If any conditions are not fulfilled, the transaction is rejected before the movement of funds. This reduces the return and reversal of payments and funds transfers if transactions are rejected by parties later in the flow as all parties have to approve the transaction before it is effected.

### 3. Traceability

All payment/fund transfer statuses will be recorded by smart contracts on the blockchain. This provides traceability to agents involved and customers who have initiated the transfer. The Payment Utility Platform emit events and inform parties involved in the transactions via blockchain logs. Participants may also enquire payment/fund transfer statuses via the Payment Utility Platform. This is visible and provides traceability.

In an embodiment, the plurality of conditions further comprises an external condition which must be fulfilled prior to execution of the payment transaction.

In an embodiment, the blockchain stores a mapping of a function onto the external condition.

In an embodiment, wherein the function depends on an external data source.

In an embodiment, the smart contract indicates a sequence in which the plurality of conditions must be fulfilled and the method further comprises determining that the conditions are fulfilled according to the sequence.

In an embodiment, generating the smart contract instance comprises generating the smart contract instance according to one of a plurality of smart contract templates.

In an embodiment, the transaction initiation request comprises a message formatted according to the ISO 20022 standard.

In an embodiment, the transaction initiation request comprises a pacs.008 message.

In an embodiment, the messages sent and received from the respective transaction parties are formatted according to the ISO 20022 standard.

In an embodiment, the messages sent and received from the respective transaction parties are pacs.002 and/or pacs.008 messages.

According to a second aspect of the present disclosure a computer readable medium storing processor executable instructions which when executed on a processor cause the processor to carry out a method as set out above is provided.

According to a third aspect of the present disclosure a payment transaction processing system comprising is provided. The payment processing system comprises: a processor and a data storage device storing computer program instructions operable to cause the processor to: receive a transaction initiation request for a payment transaction involving a plurality of transaction parties; generate a smart contract instance for the payment transaction and storing the smart contract instance in a smart contract on a blockchain, the smart contract having a plurality of conditions which must be fulfilled prior to execution of the payment transaction, wherein the plurality of conditions comprises transaction party conditions which must be fulfilled by respective transaction parties from the plurality of transaction parties; for each transaction party condition of the transaction party conditions: send a message to a respective transaction party corresponding to the transaction party condition; receive a response from the respective transaction party indicating that the respective transaction party condition has been fulfilled; and update the smart contract to indicate that the respective transaction party condition has been fulfilled; in response to determining that each condition of the plurality of conditions has been fulfilled, send a transaction execution message to a transaction execution party of the plurality of transaction parties to execute part of the payment transaction; receive a transaction execution response from the transaction execution party indicating that a part of the transaction has been executed; and update the smart contract to indicate that the part of the transaction has been executed.

In an embodiment, the plurality of conditions further comprises an external condition which must be fulfilled prior to execution of the payment transaction.

In an embodiment, the blockchain stores a mapping of a function onto the external condition.

In an embodiment, the function depends on an external data source.

In an embodiment, the smart contract indicates a sequence in which the plurality of conditions must be fulfilled and the data storage further stores computer program instructions operable to cause the processor to: determine that the conditions are fulfilled according to the sequence.

In an embodiment, the data storage further stores computer program instructions operable to cause the processor to: generate the smart contract instance by generating the smart contract instance according to one of a plurality of smart contract templates.

In an embodiment, the transaction initiation request comprises a message formatted according to the ISO 20022 standard.

In an embodiment, the messages sent and received from the respective transaction parties are formatted according to the ISO 20022 standard.

In an embodiment, the messages sent and received from the respective transaction parties are pacs.002 and/or pacs.008 messages.

### BRIEF DESCRIPTION OF THE DRAWINGS

In the following, embodiments of the present invention will be described as non-limiting examples with reference to the accompanying drawings in which:

FIG. 1 is a block diagram showing a network for transaction processing using a blockchain according to an embodiment of the present invention;

FIG. 2 is a block diagram showing a payment utility platform system according to an embodiment of the present invention;

FIG. 3 is a flowchart showing a transaction processing method according to an embodiment of the present invention;

FIG. 4 is a message flow diagram showing a transaction processing method according to an embodiment of the present invention;

FIG. 5 is a block diagram showing the indexer services of a payment utility platform according to an embodiment of the present invention;

FIG. 6 is a block diagram showing interaction between an indexer and a blockchain in an embodiment of the present invention;

FIG. 7 shows smart contract templates used in embodiments of the present invention; and

FIG. 8 is a message flow diagram showing processing in a payment utility platform system according to an embodiment of the present invention.

### DETAILED DESCRIPTION

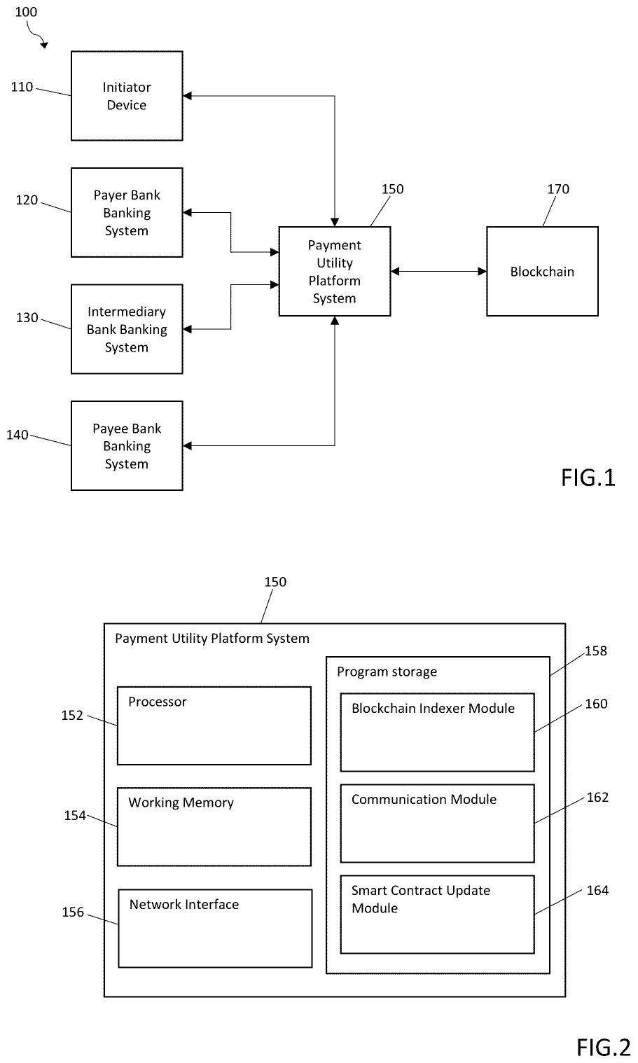

FIG. 1 shows a network for transaction processing using a blockchain according to an embodiment of the present invention. The network 100 comprises an initiator device 110, a payer bank banking system 120, an intermediary bank banking system 130, a payee bank banking system 140, a payment utility platform system 150 and a blockchain 170.

The initiator device 110 is a computing device such as a computer or smart phone used by an initiator or a transaction. The payer bank banking system 120, the intermediary bank banking system 130 and the payee bank banking system 140 are banking systems such as servers associated with banks involved in processing a payment transaction initiated by the initiator. The payment utility platform system 150 is a computer system which allows the implementation and tracking of payment transactions to be carried out using the blockchain 170. As is described in more detail below, the payment utility platform system 150 creates and allows updating of a smart contract on the blockchain 170 to track each stage of the payment transaction. The blockchain 170 is a system of recording information in a way that makes it difficult or impossible to change, hack, or cheat the system. A blockchain is essentially a digital ledger of transactions that is duplicated and distributed across the entire network of computer systems on the blockchain. Each block in the chain contains several transactions, and every time a new transaction occurs on the blockchain, a record of that transaction is added to every participant's ledger. The decentralised database managed by multiple participants is known as Distributed Ledger Technology (DLT). Blockchain is a type of DLT in which transactions are recorded with an immutable cryptographic signature called a hash. The payment utility platform system 150 is designed for a blockchain platform and is agnostic to blockchain technology. For example, the blockchain 170 may be implemented on Ethereum, Quorum, Hyperledger Fabric, and other blockchain technology. Blockchain/Distributed Ledger technology is used with each participant interacting with the blockchain directly via API functions via an agent or a smart contract function call directly with their own node.

The blockchain 170 is formed from a plurality of nodes. The payer bank banking system 120, the intermediary bank banking system 130 and the payee bank banking system 140 may act as nodes of the blockchain 170.

FIG. 2 shows a payment utility platform system according to an embodiment of the present invention. The payment utility platform system 150 is a computer system with memory that stores computer program modules which implement payment transaction processing methods according to embodiments of the present invention.

The payment utility platform system 150 comprises a processor 152, a working memory 154, a network interface 156, and program storage 158. The processor 152 may be implemented as one or more central processing unit (CPU) chips. The program storage 158 is a non-volatile storage device such as a hard disk drive which stores computer program modules. The computer program modules are loaded into the working memory 154 for execution by the processor 152. The network interface 156 is an interface which allows data, such as image data to be received by the payment utility platform system 150. The network interface 156 may be a wireless network interface such as a Wi-Fi or Bluetooth interface, alternatively it may be a wired interface.

The program storage 158 stores a blockchain indexer module 160, a communication module 162, and a smart contract update module 164. The computer program modules cause the processor 152 to execute various geographic data processing which is described in more detail below. The program storage 158 may be referred to in some contexts as computer readable storage media and/or non-transitory computer readable media. As depicted in FIG. 2, the computer program modules are distinct modules which perform respective functions implemented by the payment utility platform system 150. It will be appreciated that the boundaries between these modules are exemplary only, and that alternative embodiments may merge modules or impose an alternative decomposition of functionality of modules. For example, the modules discussed herein may be decomposed into sub-modules to be executed as multiple computer processes, and, optionally, on multiple computers. Moreover, alternative embodiments may combine multiple instances of a particular module or sub-module. It will also be appreciated that, while a software implementation of the computer program modules is described herein, these may alternatively be implemented as one or more hardware modules (such as field-programmable gate array(s) or application-specific integrated circuit(s)) comprising circuitry which implements equivalent functionality to that implemented in software.

The blockchain indexer module 160 allows the payment utility platform system 150 to interface with the blockchain 170 and create and update smart contracts stored on the blockchain 170. The communication module 162 allows the payment utility platform 150 to communicate with the initiator device 110, the payer bank banking system 120, the intermediary bank banking system 130 and the payee bank banking system 140. The smart contract update module 164 allows a user to create and update smart contract templates stored on the blockchain 170.

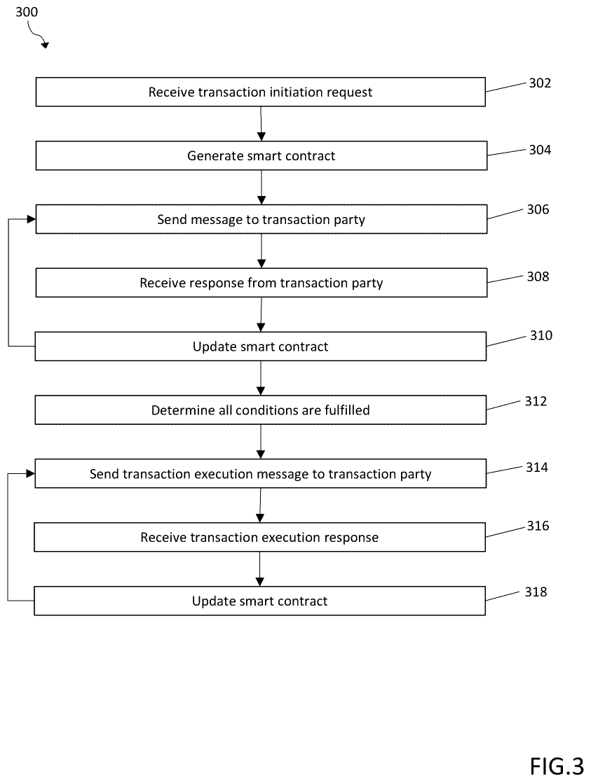

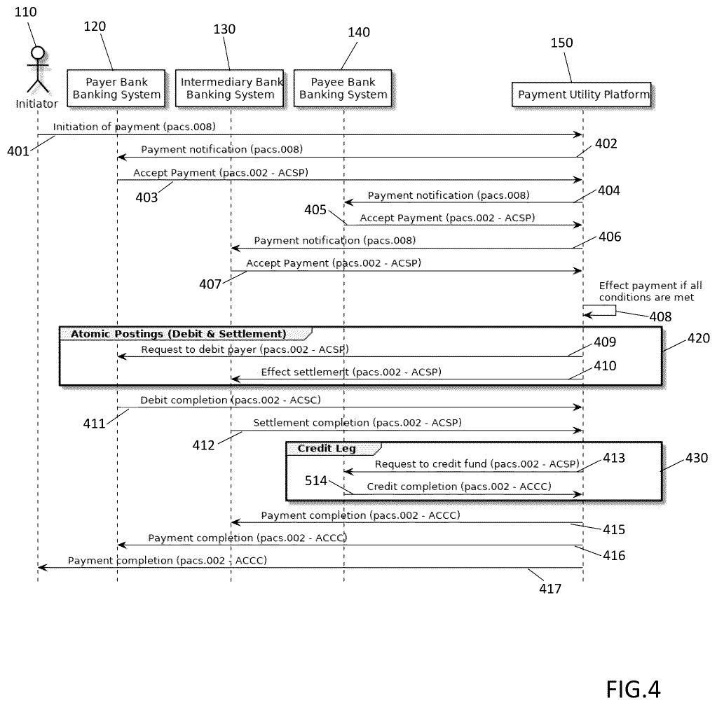

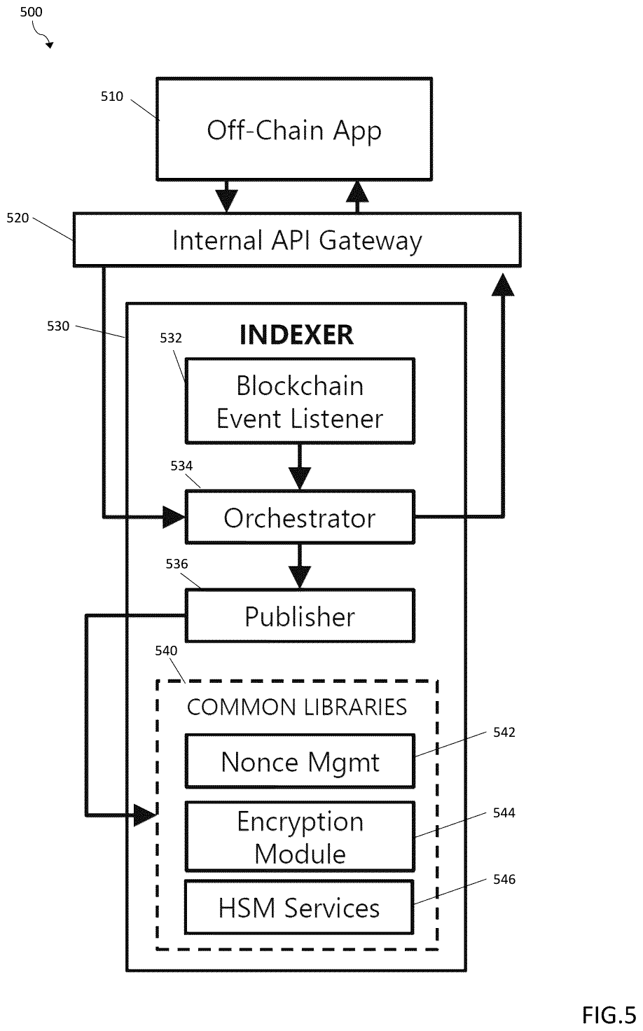

A payment transaction processing method according to an embodiment of the present invention will now be described with reference to FIG. 3 and FIG. 4. FIG. 3 is a flowchart showing a transaction processing method according to an embodiment of the present invention and FIG. 4 is a message flow diagram showing a transaction processing method according to an embodiment of the present invention.

The method 300 shown in FIG. 3 is carried out by the payment utility platform 150 shown in FIG. 2 and the message flow shown in FIG. 4 takes place on the network 100 shown in FIG. 1. The participants can interact with the payment utility platform system 150 via application program interfaces (APIs) in JSON format. The transfer details aligned with ISO messaging standards will be included in the payload of the JSON message. The API will be received and parsed by blockchain indexer module 160 which interacts and updates the smart contracts stored on the blockchain 170 based on the API calls. Information is written into the blockchain via smart contract function calls. Setter methods are defined in the smart contract to update the state of the transaction lifecycle. With statuses stored in smart contracts, getter methods are constructed to allow for enquiry of the transaction status stored in the blockchain 170. All transactions published into the blockchain will be stored and written as logs emitted via events called within the payment utility platform smart contracts. Participants will receive the information via their own node's indexer service.

As shown in FIG. 4, the process is initiated by the initiator device 110 sending a transaction initiation request message 401 to the payment utility platform system 150. For example, the Initiator is looking to transfer S$10M from its own Payer Bank to a Payee via its Payee Bank via the payment utility platform system 150 to fulfil and settle the transfer. The Payment Utility smart contract function is called to create the request with the Payment Utility Platform. This will be settled via an Intermediary Bank. The initiation message 201 may be a pacs.008 message according to the ISO 20022 standard.

In step 302 of the method 300 shown in FIG. 3, the communication module 162 of the payment utility platform system 150 receives the transaction initiation request message 401. The transaction initiation request message 401 may be received via the network interface 156 of the payment utility system 150.

In step 304, the blockchain indexer module 160 of the payment utility platform system 150 sends a transaction payload to a smart contract stored on the blockchain to generate a smart contract instance corresponding to the transaction. As will be described in more detail below, the smart contract instance may be generated from a smart contract stored on the blockchain. The smart contract has a plurality of conditions which must be fulfilled before the transaction is executed.

In step 306, the communication module 162 of the payment utility platform system 150 sends a message to a transaction party corresponding to one of the conditions. In this disclosure some of the conditions are referred to as transaction party conditions. These are conditions which are fulfilled by transaction parties such as the payer bank, the intermediary bank and the payee bank. Other conditions which depend on external factors are referred to as external conditions. Examples of external conditions will be discussed in more detail below.

In step 308, the communication module 162 of the payment utility platform system 150 receives a response from the transaction party indicating that the transaction party condition has been completed.

In step 310, the blockchain indexer module 160 of the payment utility platform system 150 updates the smart contract stored in the blockchain 170 to indicate that the transaction party condition has been fulfilled.

Referring now to FIG. 4, the payment utility platform system 150 sends a payment notification 402 to the payer bank banking system 120. The payment notification 402 is a pacs.008 message in the ISO 20022 format. In response, the payer bank banking system 120 sends an accept payment message 403. The accept payment message 403 is a pacs.002 message which indicates “ACSP”, this is the ISO 20022 code for “settlement in progress”.

After the payment utility platform system 150 receives the accept payment message 403 from the payer bank banking system 120, the blockchain indexer module 160 of the payment utility platform system 150 updates the smart contract to indicate that the first transaction party condition has been fulfilled.

Then, the payment utility platform system 150 sends a payment notification 404 to the payee bank banking system 140. The payment notification 404 is a pacs.008 message in the ISO 20022 format. In response, the payee bank banking system 140 sends an accept payment message 405. The accept payment message 405 is a pacs. 002 message which indicates “ACSP”, this is the ISO 20022 code for “settlement in progress”. After the payment utility platform system 150 receives the accept payment message 405 from the payee bank banking system 140, the blockchain indexer module 160 of the payment utility platform system 150 updates the smart contract to indicate that the second transaction party condition has been fulfilled.

Then, the payment utility platform system 150 sends a payment notification 406 to the intermediary bank banking system 130. The payment notification 406 is a pacs.008 message in the ISO 20022 format. In response, the intermediary bank banking system 130 sends an accept payment message 407. The accept payment message 407 is a pacs.002 message which indicates “ACSP”, this is the ISO 20022 code for “settlement in progress”. After the payment utility platform system 150 receives the accept payment message 407 from the intermediary bank banking system 130, the blockchain indexer module 160 of the payment utility platform system 150 updates the smart contract to indicate that the third transaction party condition has been fulfilled.

As described above, the steps 306, 308 and 310 are repeated for each of the transaction party conditions. In this example there are three transaction party conditions which are fulfilled before the transaction is executed. It will be appreciated that for different types of transaction there may be a different number of transaction party conditions to be fulfilled. In the example described above, the transaction party conditions are fulfilled in a set sequence in which a payment notification message 404 is sent to the payee bank banking system 140 once the accept payment message 403 has been received from the payer bank banking system 120. Thus, the first transaction party condition must be fulfilled before determining whether the second transaction party condition is fulfilled.

In step 312, the blockchain indexer module 160 of the payment utility platform 150 determines whether all of the conditions of the smart contract are fulfilled. Once all of the conditions of the smart contract are fulfilled, the method moves to step 314.

In step 314, the communication module 162 of the payment utility platform 150 sends a transaction execution message to one of the transaction parties to initiate execution of the payment transaction.

In step 316, the communication module 162 of the payment utility platform 150 receives a transaction execution response from the transaction party which indicates that the execution of the payment transaction by the transaction party has been carried out.

In step 218, the blockchain indexer module 160 of the payment utility platform 150 updates the smart contract to indicate that the transaction has been executed by the transaction party.

The completion of the payment transaction may require the transaction to be executed by multiple parties.

Referring now to FIG. 4, the payment utility platform system 150 will effect the payment transaction if all the conditions are met 408.

The processor effecting the payment transaction comprises an atomic postings (debit and settlement) procedure 420 and a credit leg procedure 430. As shown in FIG. 4, the atomic postings (debit and settlement) procedure 420 comprises the payment utility platform system 150 sending a request to debit payer message 409 to the payer bank banking system 120 and an effect settlement message 410 to the intermediary bank banking system 130. The request to debit payer message 409 is a is a pacs.002 message which indicates “ACSP”, this is the ISO 20022 code for “settlement in progress”. The effect settlement message 410 is also a pacs.002 message which indicates “ACSP”.

Once the payer account has been debited, the payer bank banking system 120 sends a debit completion message 411 to the payment utility platform system 150. The debit completion message 411 is a pacs. 002 message which indicates “ACSC”, this is the ISO 20022 code for “Accepted Settlement Completed”. Upon receiving the debit completion message 411, the payment utility platform system 150 updates the smart contract on the blockchain to indicate that the debit has been completed.

Once the intermediary bank banking system 130 has effected settlement, it sends a settlement completion message 412 to the payment utility platform system 150. The settlement completion message indicates “ACSP”, this is the ISO 20022 code for “settlement in progress”. Upon receiving the settlement completion message 412, the payment utility platform system 150 updates the smart contract on the blockchain to indicate that the settlement has been completed.

After the smart contract is updated to indicate that the debit has been completed and the settlement has been completed, the credit leg procedure 430 begins. The credit leg procedure 430 comprises the payment utility platform 150 sending a request to credit funds message 413 to the payee bank banking system 140. The request to credit funds message 413 is a pacs.002 message which “ACSP”, this is the ISO 20022 code for “settlement in progress”. Once the funds have been credited, the payee bank banking system 140 sends a credit completion message 415 to the payment utility platform system 150. The credit completion message 514 is a a pacs.002 message which indicates “ACCC”, this is the ISO 20022 code for “Accepted Credit Settlement Completed”. The credit completion message 514 indicates that settlement on the creditor's account has been completed. In response to receiving the credit completion message 514, the payment utility platform 150 updates the smart contract to indicate that the settlement on the creditor's account has been completed and sends a payment completion message 415 to the intermediary bank banking system 130, a payment completion message 416 to the payer bank banking system 120 and a payment completion message 417 to the initiator device 110. Each of the payment completion messages is a pacs.002 message which indicates “ACCC”, this is the ISO 20022 code for “Accepted Credit Settlement Completed”.

As described above, the steps 314, 316 and 318 repeated for each stage of the execution of the payment transaction. For different transaction types there may be a different number of stages for execution of the transaction.

FIG. 5 is a block diagram showing the indexer services of a payment utility platform according to an embodiment of the present invention. As shown in FIG. 5, the payment utility platform 500 is implemented as an off-chain app 510 which communicates with an internal application program interface (API) gateway 520. The internal API gateway 520 communicates with an orchestrator 534 which forms part of the indexer 530.

The indexer services contain services which facilitates the interaction with the Payment Utility Smart Contracts on the blockchain. The indexer service contains but is not limited to the following components/microservices required for the facilitation of the Payment Utility Platform on different blockchain technologies.

The indexer 530 comprises a blockchain event listener 532, the orchestrator 534, a publisher 536 and common libraries. The common libraries 540 comprise a nonce management 542, an encryption module 544 and hardware security module (HSM) services 546.

The API gateway 520 is the entry point to the application where requests will be authenticated, ensuring only requests from trusted sources are processed. This is achieved with the use of security protocols and practices such as whitelisting, certification validation, client entitlement check, data encryption and digital signing. Request format will be aligned to ISO20022 or other industry standards where appropriate.

The blockchain event listener 532 receives and broadcasts events emitted from the payment utility platform system 150 with which relevant parties interact. The blockchain event listener 532 allows them to follow up with the relevant responses.

The orchestrator 534 maps the API request to the correct smart contract function and extracts the required data from the API request for the smart contract function. In addition, the orchestrator 534 interacts with the API gateway 520 to send outward API messages based on the blockchain events corresponding to the transaction status throughout its lifecycle.

The publisher 536 forms the blockchain payload, facilitates the signing of the transaction and publishes hashed transaction to the chain. The publisher 536 interacts with the nonce management 542, HSM services 546 and other components to construct the payload to publish into the blockchain.

The nonce management 542 generates uniquely generated reference numbers (that will only be used once) which are be used to identify transactions or wallets held on the blockchain. The nonce management 542 service will call into the blockchain to confirm on the last number generated before assigning the next number. The nonce management 542 service will subscribe to into the blockchain events to confirm on the successful utilization of the nonce before assigning the next number. This is to ensure no duplicate transactions or wallets are being transacted or held on the blockchain.

The HSM Services 546 integrates with the physical/virtual HSM to perform transaction signing using the generate nonce before submitting the transaction to the blockchain.

The encryption module 544 handles the encryption of the payload to be published into the blockchain and decryption of the events emitted from the blockchain. This module is blockchain technology dependent.

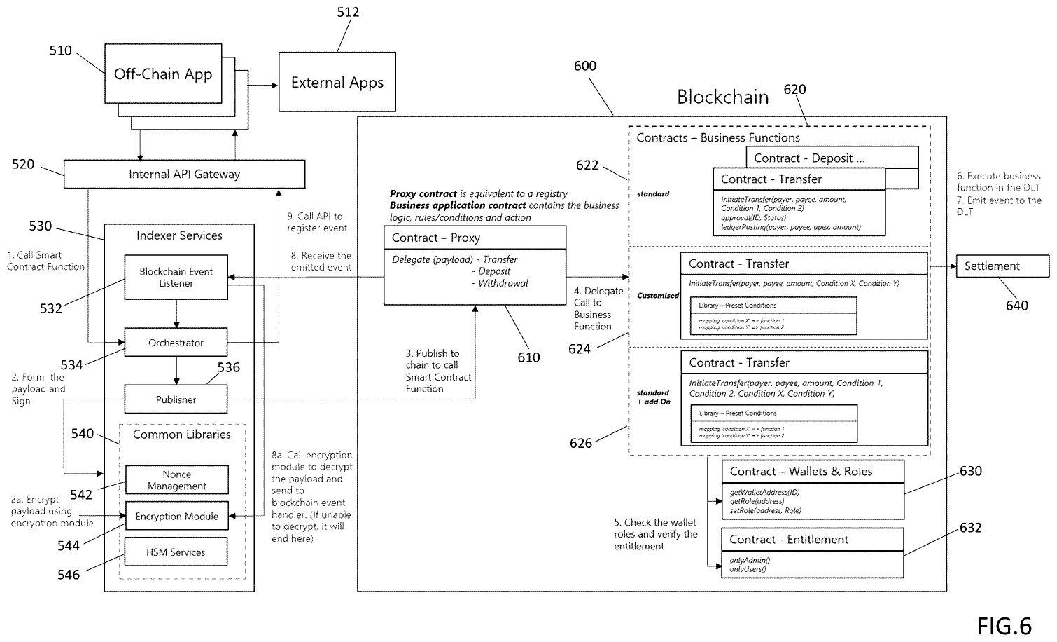

The interaction of the indexer 530 with the blockchain is described in more detail below with reference to FIG. 6.

FIG. 6 is a block diagram showing interaction between an indexer and a blockchain in an embodiment of the present invention. As described above with reference to FIG. 5, the off-chain app is coupled an internal application program interface (API) gateway 520. The internal API gateway 520 communicates with an orchestrator 534 which forms part of the indexer 530. The off-chain app 510 is also coupled to external apps 512.

The indexer 530 comprises a blockchain event listener 532, the orchestrator 534, a publisher 536 and common libraries. The common libraries 540 comprise a nonce manager 542, an encryption module 544 and hardware security module (HSM) services 546.

The blockchain 600 stores a contract proxy 610, a set of smart contract templates 620 and a wallets and roles contract 630 and an entitlement contract 632.

The contract proxy 610 acts as a registry to interface with any non-blockchain components. It will contain the functions to call the smart contract templates 620 which are stored on the blockchain 600. This facilitates upgradability of the smart contracts. The smart contract templates 620 contain the rules and conditions needed to facilitate the use cases. Each use case with its own set of conditions will be deployed as a separate smart contract. The smart contract templates follow a flexible conditions design. New transactions will also be stored as instances of the smart contract templates. Smart contracts based on the smart contract templates will interact with the wallets and roles contract 630, and entitlement contracts 632 to authenticate the requestor before processing the message.

The wallets and roles contract 630 contains the different participants of the payment utility platform system 150. Each participant will also be assigned roles (payer bank, payee bank, settlement bank, etc). This helps to group users to roles based on their access requirements. The entitlement contract 632 contains the rights of roles. This acts as an accessibility matrix for different roles. This lists the access of each role on the smart contract functions it is entitled to interact with.

To support standard payment/fund transfer practices and flows, the Payment Utility Platform has fixed templates for basic and generic global payment/fund transfer processes.

To support use case specific conditions (based on industry, regulatory and product offering needs) or other localised conditions, the payment utility platform system allows for flexibility in defining conditions before the effecting of transfers. The conditions applied to the payment/fund transfer will be universally recognised by all participants of the network (unless otherwise mentioned). These dynamic conditions are constantly refined and enhanced with ever changing payment/fund transfer needs and will be availed to participants. The conditions may be added or edited using the smart contract update module 164 of the payment utility platform system 150.

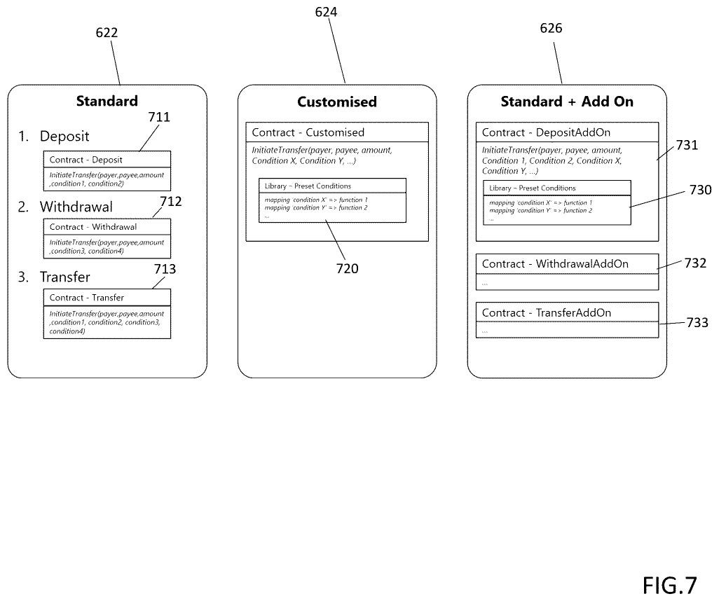

In general, the payment utility platform system 150 orchestration falls into 3 broad categorisations: Standard smart contract templates 622, customized smart contract templates 624 and standard smart contract with add on templates 626. The standard smart contract templates 622 correspond to a fixed generic orchestration. The customized smart contract templates 624 allow a user to customize the conditions for the contract. The standard smart contract with add on templates 626 allow for customization based on the standard templates. The smart contract templates are described in more detail below with reference to FIG. 7.

As shown in FIG. 6, in response to a transaction initiation request, the internal API gateway 520 causes the orchestrator 534 to call the smart contract function which creates a smart contract using one of the smart contract templates 620. The publisher 536 forms a payload message and signs the payload. This payload is then published to the blockchain 600 to call the smart contract function using the contract proxy 610. The contract proxy function calls the business functions from the relevant smart contract template 620. The wallet and roles contract 630 and the entitlement contract 632 are called to verify the entitlement of the initiator. Then the business functions defined in the smart contract template are executed to the distributed ledger technology and the event is stored on the blockchain. This corresponds to the settlement box 640 shown in FIG. 6.

FIG. 7 shows smart contract templates used in embodiments of the present invention. As shown in FIG. 7, the smart contract templates comprise standard smart contract templates 622, customized smart contract templates 624 and standard smart contract with add on templates 626. The standard smart contract templates 622 comprise a deposit template 711, a withdrawal template 712 and a transfer template 713. Each template specifies the parties to the smart contract, details of the action such as the amount concerned and conditions. The conditions may be contract party conditions which specify processes that must be completed by the parties before the smart contract is executed.

The customised smart contract templates 624 specify details of the parties and the action as discussed above. In addition to this, the customised smart contract templates 624 also comprise a library 720 of preset conditions. This library 720 maps conditions onto functions. The mappings may involve external conditions. The customised smart contract templates 624 contain the codes of the conditions for effecting transfers. New conditions to be added may be added. Additional conditions as required by bank's individual use cases can be customised and updated as required. Dynamic conditions thus allow for Payment Utility Platform to be all encompassing and adaptable to fit into any use case required. The following are examples of possible conditions: block fund, sanctions screening, transfer types accepted, account name validation, future/post-dated conditions, stock pricing, foreign exchange rate, other dependencies, recurring payments, receival of shares, and financial institution available funds.

The code for functions will be within a Customised smart contract. The smart contract will also contain a mapping of conditions to user inputs. This allows for initiators to specify the different conditions required to effect the transfer. Additional parameters will also be required for the different kind of conditions specified. For instance, the value to meet for external environment dependent conditions will be an input during request initiation. This can be used effect payments for FX purchase once the FX rate for SGD for example reaches 1 USD: 1.45 SGD.

During the transaction initiation, the codes of the conditions will be compiled together into a new transaction within the customised smart contract. The conditional codes will then be invoked to orchestrate the transfer accordingly.

The standard smart contract templates with add on 626 comprise a deposit template 731, a withdrawal template 732 and a transfer template 733. Each of the templates comprises a library 730 of pre-set conditions. Thus, the payment utility platform system 150 also supports generic transfer flows which require additional customisation. This will allow banks to add additional dynamic conditions on top of base use cases, without the need to reconstruct flows from scratch. Each static flow with dynamic conditions will also be deployed on individual smart contracts. For instance, deposit with add on conditions, withdrawal with add on conditions and transfer with add on conditions.

The library of pre-set conditions defines parameters for the translation of user inputs to conditional codes will be achieved via a condition library/mapping table. This library can be maintained by the usage of smart contract functions.

Initiators will define conditions required for the transaction to be effected. These inputs will then be linked by the mapping table to the functions required to effect the conditions. These mapping of conditions will be coded into the Customised and Add On smart contract templates. Additional user parameters can be provided to the conditions during the request initiation. These will act as additional factors in conditions processing for effecting transfers.

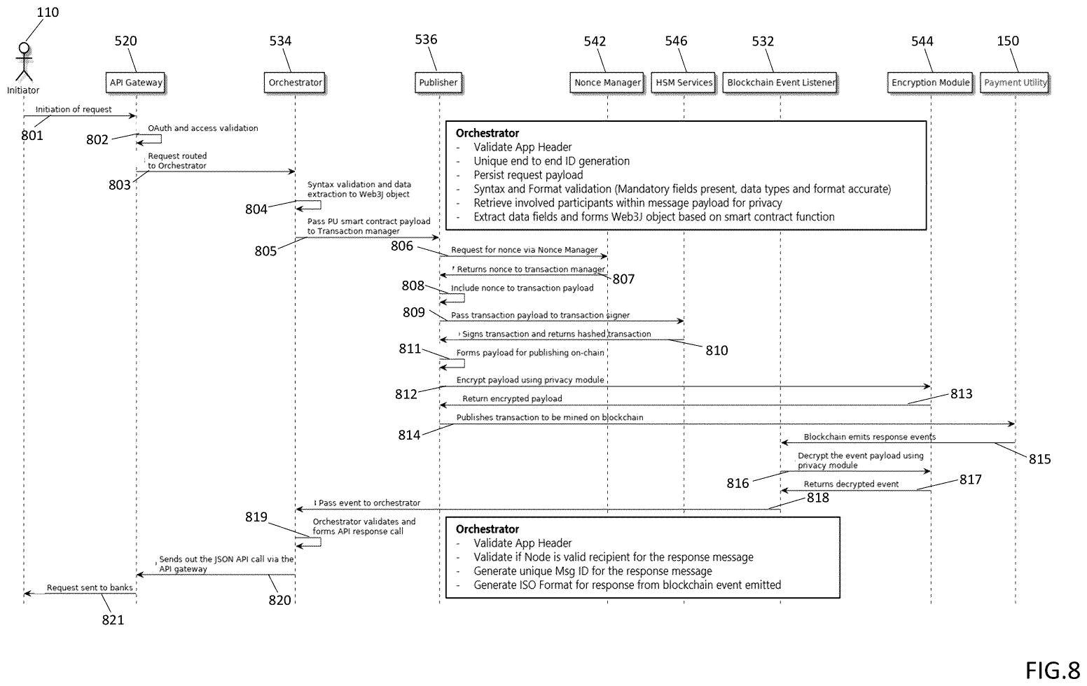

FIG. 8 is a message flow diagram showing processing in a payment utility platform system according to an embodiment of the present invention. The initiator 110 sends a transaction initiation request 801 to the API gateway 520. The API gateway 520 then validates 802 the API call by performing OAuth token validation and access validation. The API gateway 520 sends the request 803 to the orchestrator 534. The orchestrator 534 validates and processes 804 the message payload. This comprises validating the app header, generation of a unique end to end ID, persist request payload, syntax and format validation, retrieving involved participants within message payload for privacy and extracting data fields and forms Web3J object based on smart contract function. The orchestrator 534 then sends the smart contract payload 805 to the publisher 536. The publisher 536 requests 806 a unique nonce from the nonce manager 542. The nonce manager 542 returns a unique nonce 807 for the transaction. The publisher 536 includes 808 the unique nonce with the transaction payload. The publisher 536 then sends the transaction payload 809 to the HSM services 546 which act as a transaction signer. The transaction signer signs the transaction and returns a hashed transaction 810. The publisher 836 forms the payload 811 for publishing on-chain. The publisher 536 then encrypts 812 the payload using the encryption module 544. The encryption module 544 returns an encrypted payload 813. The publisher sends the transaction 814 to the blockchain to be mined. The payment utility platform system 150 emits the response events 815 which will be picked up by the blockchain event listener 532. The blockchain event listener 532 sends the emitted event payload 816 to the encryption module 544 for decryption. If successful, the encryption module 544 returns the decrypted event payload 817 to the blockchain event listener 532. The blockchain event listener 532 passes the decrypted payload 818 to the orchestrator 534. The orchestrator 534 validates the emitted event and formulates the appropriate API response call 819. The validation and functions of the orchestrator are as follows: validate app header, validate if node is valid recipient for the response message, generate unique Msg ID for the response message, and generate ISO Format for response from blockchain event emitted. The orchestrator 534 sends the formulated JSON API response payload 820 to the API gateway 520 for inclusion into the outbound traffic. The API gateway 820 sends the API call 821 to the initiator 110.

Whilst the foregoing description has described exemplary embodiments, it will be understood by those skilled in the art that many variations of the embodiments can be made within the scope and spirit of the present invention.

1. A transaction processing method comprising:
receiving a transaction initiation request for a payment transaction involving a plurality of transaction parties;
generating a smart contract instance for the payment transaction and storing the smart contract instance in a smart contract on a blockchain, the smart contract having a plurality of conditions which are fulfilled prior to execution of the payment transaction, wherein the plurality of conditions comprises transaction party conditions which are fulfilled by respective transaction parties from the plurality of transaction parties;
for each transaction party condition of the transaction party conditions:
sending a message to a respective transaction party corresponding to the transaction party condition;
receiving a response from the respective transaction party indicating that the respective transaction party condition has been fulfilled; and
updating the smart contract to indicate that the respective transaction party condition has been fulfilled;
in response to determining that each condition of the plurality of conditions has been fulfilled, sending a transaction execution message to a transaction execution party of the plurality of transaction parties to execute part of the payment transaction;
receiving a transaction execution response from the transaction execution party indicating that a part of the transaction has been executed; and
updating the smart contract to indicate that the part of the transaction has been executed.

2. The method according to claim 1, wherein the plurality of conditions further comprises an external condition which is fulfilled prior to execution of the payment transaction.

3. The method according to claim 2, wherein the blockchain stores a mapping of a function onto the external condition.

4. The method according to claim 3, wherein the function depends on an external data source.

5. The method according to claim 1, wherein the smart contract indicates a sequence in which the plurality of conditions are fulfilled and the method further comprises determining that the conditions are fulfilled according to the sequence.

6. The method according to claim 1, wherein generating the smart contract instance comprises generating the smart contract instance according to one of a plurality of smart contract templates.

7. The method according to claim 1, wherein the transaction initiation request comprises a message formatted according to the ISO 20022 standard.

8. The method according to claim 7, wherein the transaction initiation request comprises a pacs.008 message.

9. The method according to claim 1, wherein the messages sent and received from the respective transaction parties are formatted according to the ISO 20022 standard.

10. The method according to claim 9, wherein the messages sent and received from the respective transaction parties are pacs.002 and/or pacs.008 messages.

11. A non-transitory computer readable medium storing processor executable instructions which when executed on a processor cause the processor to carry out the method according to claim 1.

12. A payment transaction processing system comprising: a processor and a data storage device storing computer program instructions operable to cause the processor to:
receive a transaction initiation request for a payment transaction involving a plurality of transaction parties;
generate a smart contract instance for the payment transaction and storing the smart contract instance in a smart contract on a blockchain, the smart contract having a plurality of conditions which are fulfilled prior to execution of the payment transaction, wherein the plurality of conditions comprises transaction party conditions which are fulfilled by respective transaction parties from the plurality of transaction parties;
for each transaction party condition of the transaction party conditions:
send a message to a respective transaction party corresponding to the transaction party condition;
receive a response from the respective transaction party indicating that the respective transaction party condition has been fulfilled; and
update the smart contract to indicate that the respective transaction party condition has been fulfilled;
in response to determining that each condition of the plurality of conditions has been fulfilled, send a transaction execution message to a transaction execution party of the plurality of transaction parties to execute part of the payment transaction;
receive a transaction execution response from the transaction execution party indicating that a part of the transaction has been executed; and
update the smart contract to indicate that the part of the transaction has been executed.

13. The payment transaction processing system according to claim 12, wherein the plurality of conditions further comprises an external condition which is fulfilled prior to execution of the payment transaction.

14. The payment transaction processing system according to claim 13, wherein the blockchain stores a mapping of a function onto the external condition.

15. The payment transaction processing system according to claim 14, wherein the function depends on an external data source.

16. The payment transaction processing system according to claim 12, wherein the smart contract indicates a sequence in which the plurality of conditions are fulfilled and the data storage further stores computer program instructions operable to cause the processor to: determine that the conditions are fulfilled according to the sequence.

17. The payment transaction processing system according to claim 12, wherein the data storage further stores computer program instructions operable to cause the processor to: generate the smart contract instance by generating the smart contract instance according to one of a plurality of smart contract templates.

18. The payment transaction processing system according to claim 12, wherein the transaction initiation request comprises a message formatted according to the ISO 20022 standard.

19. The payment transaction processing system according to claim 12, wherein the messages sent and received from the respective transaction parties are formatted according to the ISO 20022 standard.

20. The payment transaction processing system according to claim 19, wherein the messages sent and received from the respective transaction parties are pacs.002 and/or pacs.008 messages.
